(19) United States
(12) Patent Application Publication
(10) Pub. No.: US 2022/0309476 A1
(43) Pub. Date: Sep. 29, 2022

(54) METHODS AND SYSTEMS FOR FACILITATING VERIFYING A RECYCLING PROCESS OF A RECYCLABLE ITEM

(71) Applicant: Stanley Chen, new york, NY (US)

(72) Inventor: Stanley Chen, new york, NY (US)

(73) Assignee: Recyclego inc, irvington, NJ (US)

(21) Appl. No.: 17/209,218

(22) Filed: Mar. 23, 2021

(51) Int. Cl. G06Q 10/00; G06F 16/27; G06Q 30/00; G01N 25/20

(52) U.S. Cl. CPC G06Q 10/30; G06F 16/27; G06Q 30/018; G01N 25/20

(57) ABSTRACT

Disclosed herein is a method for facilitating verifying a recycling process of a recyclable item. Accordingly, the method may include receiving, using a communication device, a recyclable item identifier of the recyclable item from a device, determining, using a processing device, estimated yield data representing an estimated yield associated with the recyclable item based on the recyclable item identifier, storing, using a storage device, the estimated yield data to a distributed ledger, receiving, using the communication device, actual yield data representing an actual yield associated with at least one product from a yield sensor, and comparing, using the processing device, the actual yield data with the estimated yield data. Further, the method may include verifying, using the processing device, the recycling process based on the comparing. Further, the method may include storing, using the storage device, the actual yield data associated with the recyclable item in the distributed ledger.

### FIELD OF THE INVENTION

Generally, the present disclosure relates to the field of data processing. More specifically, the present disclosure relates to methods and systems for facilitating verifying a recycling process of a recyclable item.

### BACKGROUND OF THE INVENTION

Plastic is the most enormously used material by mankind. Further, every person in the contemporary era is surrounded by plastic in one form or the other. However, the plastic is non-biodegradable and can take up to several thousand years to degrade back into the environment. Consequently, plastic causes environmental pollution. Therefore, it becomes necessary to recycle plastic. Advanced technologies for recycling the plastic may include gasification, pyrolysis, depolymerization, etc.

Existing techniques for facilitating verifying a recycling process of a recyclable item (such as plastic) are deficient with regard to several aspects. For instance, current technologies do not allow chemical companies to get credits for recycling the plastic (such as post-consumer and hard to recycle plastic). Furthermore, current technologies do not generate a record for facilitating verification of a recycling process that may be performed by the chemical companies.

Therefore, there is a need for improved methods and systems for facilitating verifying a recycling process of a recyclable item that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating verifying a recycling process of a recyclable item, in accordance with some embodiments. Accordingly, the method may include a step of receiving, using a communication device, a recyclable item identifier of the recyclable item from at least one device. Further, the method may include a step of determining, using a processing device, estimated yield data representing an estimated yield associated with the recyclable item based on the recyclable item identifier. Further, the method may include a step of storing, using a storage device, the estimated yield data to a distributed ledger. Further, the method may include a step of receiving, using the communication device, actual yield data representing an actual yield associated with at least one product from a yield sensor. Further, the yield sensor may be configured for generating the actual yield data based on the actual yield of the at least one product produced after processing of the recyclable item using the recycling process. Further, the method may include a step of comparing, using the processing device, the actual yield data with the estimated yield data. Further, the method may include a step of verifying, using the processing device, the recycling process based on the comparing. Further, the method may include a step of storing, using the storage device, the actual yield data associated with the recyclable item in the distributed ledger.

Disclosed herein is a method for facilitating verifying a recycling process of a recyclable item, in accordance with some embodiments. Accordingly, the method may include a step of receiving, using a communication device, a recyclable item identifier of the recyclable item from at least one device. Further, the method may include a step of determining, using a processing device, estimated yield data representing an estimated yield associated with the recyclable item based on the recyclable item identifier. Further, the method may include a step of storing, using a storage device, the estimated yield data to a distributed ledger. Further, the method may include a step of receiving, using the communication device, actual yield data representing an actual yield associated with at least one product from a yield sensor. Further, the yield sensor may be configured for generating the actual yield data based on the actual yield of the at least one product produced after processing of the recyclable item using the recycling process. Further, the method may include a step of comparing, using the processing device, the actual yield data with the estimated yield data. Further, the method may include a step of verifying, using the processing device, the recycling process based on the comparing. Further, the method may include a step of storing, using the storage device, the actual yield data associated with the recyclable item in the distributed ledger. Further, the method may include a step of generating, using the processing device, a CO₂e offset associated with the recyclable item based on the comparing. Further, the method may include a step of storing, using the storage device, the CO₂e offset in the distributed ledger.

Further disclosed herein is a system for facilitating verifying a recycling process of a recyclable item, in accordance with some embodiments. Accordingly, the system may include a communication device configured for receiving a recyclable item identifier of the recyclable item from at least one device. Further, the communication device may be configured for receiving actual yield data representing an actual yield associated with at least one product from a yield sensor. Further, the yield sensor may be configured for generating the actual yield data based on the actual yield of the at least one product produced after processing of the recyclable item using the recycling process. Further, the system may include a processing device communicatively coupled with the communication device. Further, the processing device may be configured for determining estimated yield data representing an estimated yield associated with the recyclable item based on the recyclable item identifier. Further, the processing device may be configured for comparing the actual yield data with the estimated yield data. Further, the processing device may be configured for verifying the recycling process based on the comparing. Further, the system may include a storage device communicatively coupled with the processing device. Further, the storage device may be configured for storing the estimated yield data to a distributed ledger. Further, the storage device may be configured for storing the actual yield data associated with the recyclable item in the distributed ledger.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating verifying a recycling process of a recyclable item, in accordance with some embodiments.

FIG. 3 is a flowchart of a method for facilitating verifying a recycling process of a recyclable item, in accordance with some embodiments.

FIG. 4 is a flowchart of a method for generating a CO₂e offset for facilitating verifying the recycling process of the recyclable item, in accordance with some embodiments.

FIG. 5 is a flowchart of a method for identifying at least one stakeholder for facilitating verifying the recycling process of the recyclable item, in accordance with some embodiments.

FIG. 6 is a flowchart of a method for generating at least one product data for facilitating verifying the recycling process of the recyclable item, in accordance with some embodiments.

FIG. 7 is a flowchart of a method for assigning a provenance for facilitating verifying the recycling process of the recyclable item, in accordance with some embodiments.

FIG. 8 is a flowchart of a method for comparing estimated measurement data and actual measurement data for facilitating verifying the recycling process of the recyclable item, in accordance with some embodiments.

FIG. 9 is a flowchart of a method for determining the estimated yield of the recyclable item for facilitating verifying the recycling process of the recyclable item, in accordance with some embodiments.

FIG. 10 is a flowchart of a method for facilitating verifying a recycling process of a recyclable item, in accordance with some embodiments.

FIG. 11 is a flowchart of a method for identifying at least one stakeholder for facilitating the verifying the recycling process of the recyclable item, in accordance with some embodiments.

FIG. 12 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating verifying a recycling process of a recyclable item, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods and systems for facilitating verifying a recycling process of a recyclable item. The disclosed system may be configured for verifying recycling activity and subsequent CO2e offset of materials using mass balance methodology, sensors, and recording the process/stakeholder journey through proof of provenance on a distributed ledger system such as a Blockchain. Further, mass balance accounting for the advanced recycling of plastic waste, including mixed plastics, Polyethylene terephthalate (PET), polystyrene (PS), and other polymer types not mentioned here, as it is processed, by recycling, purifying, shredding, drying, pelletizing or other methods not described here, into usable states of petrochemical products, such as syngas, ultra-low sulfur diesel, naphtha, industrial wax, cellulosic plastics, polymers, monomers, synthetic crude oil, or other types of petrochemical products not mentioned here, and byproducts, such as char, processing solution, off spec products or other byproducts not mentioned here. Further, the balance of masses may be calculated using manufacturing data reported by producer technology, such as but not limited to input and out monitoring systems, used in conjunction with the producer's manufacturing and processing systems and equipment. Advanced recycling or chemical recycling may include a variety of processing systems and technology, including but not limited to: gasification, depolymerization, pyrolysis, purification, decomposition, and conversion.

Further, distributed ledger technology, such as Blockchain, may be used to track, calculate, and record the mass balance equation of recycled material. Further, the recycled material, such as plastic or plastic waste, may be considered and assigned a yield and apply mass balance formula on it as it is sent through the recycling process, namely chemical recycling or “advanced recycling”. Further, the plastic waste is first collected, the yield may be determined and measurement is determined (any type of measurement can be used), and the yield and the measurement are passed along to the final product. Making a standardized unit of measurement into a unit of mass. In some cases the standardized unit may be LHV (Lower Heat Values, in Energy/Mass units, i.e. MJ/kg), in others, the standardized unit may be carbon count (carbon chain length of the product being measured).

The mass balance equation forms a basis for a number of process engineering calculations. Further, the mass balance equation simply states that total mass in any system is always conserved. That is, Total mass in=Total mass out+Total mass accumulated in the system.

Further, the disclosed system may record GPS coordinates of boundaries themselves. Walk through the process of which the plastic pyrolysis may be done, from plastic waste to pyrolysis or other modes of chemical recycling to diesel, naphtha, polymers, monomers, or other outputs from the chemical recycling process. Further, the disclosed system may be compliant with ISCC reporting standards, so that the customers can use the blockchain to be certified. The process flow is waste plastics to naphtha, diesel, waxes, and other products. Further, the disclosed system may be configured for recording the yields of the recycled material that may be produced and the LHVs of the materials produced. This may produce a standardized yield for a #1-7 plastic package, or any other feedstock aggregate mix originating from a specific supplier. Further, the Blockchain may record that activity and that may be a reference point for that facility of how much yield going forward. Further, LHV (or carbon count, depending on methodology) of naphtha may be recorded, and upon sending the LHV of naphtha to a methane cracker, the LHV of the naphtha may be assigned to the amount of the plastics being produced (or carbon count based on polymer produced).

The mass balance accounting of material flow, following an input-output calculation through the recycling process, enables the subsequent calculation of CO2e offsets of diverting the material from the end of life applications, such as landfill or incineration. CO2e offsets may be calculated per quantity (ton) of the material.

Further, the disclosed system may be configured to track, calculate, and record the mass balance of the recycled material using the Blockchain and the mass balance equations associated with the disclosed system.

Further, the mass balance equation may assign provenance from feedstock into a product when either physical feedstock is mixed into an intermediate product where the individual item may not be identified individually, or where the feedstock is converted into a different form (in the case of plastics, the constituent monomers) and when mixed with other feedstock items.

In some cases, the standardized unit may be LHV (Lower Heat Values, in Energy/Mass units, i.e. MJ/kg), in others the standardized unit be carbon count from carbon chain length or Total Energy Content.

Further, in an instance, the plastics may be collected and aggregated into bales that are delivered to a chemical recycling facility (or facility). The facility receives the material (or the plastics), where it is prepared to be recycled. The bales are broken up, the plastics are fed into a shredder, where the plastics are shredded into plastic flakes. A sensor is used to identify the polymers or other ingredients that constitute the individual block of the material. The combined masses and components may be identified or derived from sensor data generated by the sensor. This may be recorded on the blockchain.

The plastics may be then converted to a precursor form to be used for chemical recycling. In pyrolytic reactions, the plastics are first melted and extruded into pellets that may be easily handled and processed through an extruder to the reaction chamber. Further, product gases and liquid yields may be controlled through sensors in the reaction chamber that regulate the reactions. The product gas and/or liquid is then cooled, collected, and stored. As the feedstock is used to produce products, a ‘recycled’ identity may be assigned to the product that may be produced and record information associated with the recycled identity on the blockchain. In the case of a chemical recycling process, using solution-based depolymerization techniques, resulting monomers may have a verified chain of custody from the feedstock, and the activity may be recorded on the blockchain.

Further, LHV values and masses for the product are used to assign recycled content to the monomers produced, when they are blended with other feedstocks to be used in polymer production. Further, the resulting mass of recycled polymer is then identified using LHV values and polymer types, and the recycled polymer is recorded onto the Blockchain. Using an LHV-based algorithm and mass balance foundation, a blockchain-verified recycled plastic polymer may properly be identified. Further, scale and sensor may identify weight and polymer type, and then a digital ID may be assigned and attached to the container of polymer produced.

Further, the following types of chemical recycling technologies may be tracked using the disclosed system:

1. Gasification—Further, gasification may include mixed plastics leading to the gasification of plastics. Further, the gasification of plastic may produce syngas (CynFuels=80% CynDiesel and 20% CynLite) and byproducts (Cyngas and char) [CynFuels go to refineries; CynGas is re-used as fuel in the TAC and the char is sold or taken to landfill]

2. Depolymerization—In depolymerization, PET may undergo low-energy depolymerization to Dimethyl Terephthalate (DMT) and Mono Ethylene Glycol (MEG). Further, the DMT/MEG purification may be performed for PET polymerization.

3. Two types: depolymerization and gasification Depolymerization—: PET may undergo depolymerization (glycolysis or methanolysis) to (DMT) and ethylene glycol. Further, the DMT and ethylene glycol may lead to “virgin” polyester.

Gasification—Further, the gasification may lead to mixed plastics for reforming (gasification) to produce syngas. Further, purification of syngas may be performed to produce purified syngas. Further, “building block chemicals” may be associated with cellulosic plastics (mixed with wood pulp).

4. Pyrolysis—The pyrolysis may include a mixed plastic waste (shredding, purification, drying, pelletizing) to be heated and vaporized in an oxygen-starved environment. Further, vapor may be captured and cooled. Further, hydrocarbon liquid may lead to ultra-low sulfur diesel (fuel), naphtha (input for new plastics), and industrial wax.

5. Pyrolysis (Mixed Plastics to Crude Oil)—Further, the mixed plastic may be shredded, ground for Pyrolysis. Further, synthetic crude oil may be mixed with process solution, and a separator separates the conditioned syncrude oil and process solution.

6. Pyrolysis (Polystyrene-to-Styrene Monomer (PSM)): waste PS may be melted, “densified” and added with recycled oligomers for Pyrolysis. Further, hydrocarbon gas stream, solids residue streams may lead to condensation to produce styrene monomer.

Further, the disclosed system complements traditional mechanical recycling efforts and energy recovery activities, to help build a circular economy of plastic.

Further, the disclosed system may allow chemical companies to get credit for using post-consumer, hard-to-recycle plastics as feedstock for already existing plastics manufacturing infrastructure.

Through the utilization of the distributed ledger technology, Oracle nodes (sensors of any kind that are recording information and feeding it to a Distributed Ledger Technology like Blockchain), and smart contracts, the disclosed system may be immutable, transparent to the stakeholders involved, and automated to produce verifiably true results and ensure that the disbursement of CO2e offset credits are done fairly without the need of a 3rd party to govern the disclosed system and its actions.

Further, the mass balance accounting for the advanced recycling of plastic waste, including mixed plastics, Polyethylene terephthalate (PET), polystyrene (PS), and other polymer types not mentioned here, as it is processed, by recycling, purifying, shredding, drying, pelletizing or other methods not described here, into usable states of petrochemical products, such as syngas, ultra-low sulfur diesel, naphtha, industrial wax, cellulosic plastics, polymers, monomers, synthetic crude oil, or other types of petrochemical products not mentioned here, and byproducts, such as char, processing solution, off-spec products or other byproducts not mentioned here. The balance of masses may be calculated using manufacturing data reported by producer technology, such as but not limited to input and out monitoring systems, used in conjunction with the producer's manufacturing and processing systems and equipment. Advanced recycling, or chemical recycling, may include a variety of processing systems and technology, including but not limited to: gasification, depolymerization, pyrolysis, purification, decomposition, and conversion.

Further, the disclosed system may be configured for recording recycling activity via DLT (Distributed Ledger Technologies) and calculating the recycling amount via the mass balance equation. Further, the disclosed system may be configured for verifying recycling activity and subsequent CO2e offset of materials using mass balance methodology, sensors, and recording the process/stakeholder journey through proof of provenance on a Distributed Ledger System such as the Blockchain.

Further, the variety of processing systems and technologies may be used in multiple industries for advanced or chemical recycling.

Further, the variety of processing systems and technologies used in an industry may include gasification. Further, the gasification may include gasification of mixed plastics to produce syngas (CynFuels=80% CynDiesel and 20% CynLite) and byproducts (Cyngas and char) [CynFuels go to refineries; CynGas is re-used as fuel in the TAC and the char is sold or taken to landfill]. Further, the gasification is a thermal process that converts carbonaceous materials into syngas using a limited quantity of air or oxygen.

Further, the variety of processing systems and technologies used in an industry may include depolymerization. Further, PET may undergo low-energy depolymerization leading to DMT/MEG. Further, purification may be performed that may lead to PET polymerization.

Further, the variety of processing systems and technologies used in an industry may include depolymerization and gasification. Further, the depolymerization may include PET undergo depolymerization (glycolysis or methanolysis) to produce (DMT) and ethylene glycol. Further, the DMT and ethylene glycol may lead to “virgin” polyester. Further, the gasification may include the mixed plastics to undergo reforming (gasification) to produce syngas. Further, the syngas may undergo purification to produce purified syngas. Further, “building block chemicals” may be associated with cellulosic plastics (mixed with wood pulp).

Further, the variety of processing systems and technologies used in an industry may include pyrolysis. Further, pyrolysis may include mixed plastic waste leading to (shredding, purification, drying, pelletizing) leading to heated and vaporized in an oxygen-starved environment leading to vapor is captured and cooled leading to hydrocarbon liquid leading to ultra-low sulfur diesel (fuel), naphtha (input for new plastics) and industrial wax.

Further, the variety of processing systems and technologies used in an industry may include two types of pyrolysis that may include Pyrolysis (Mixed Plastics to Crude Oil) and Pyrolysis (Polystyrene-to-Styrene Monomer (PSM). Further, the Pyrolysis (Mixed Plastics to Crude Oil) may include the mixed plastic to be shredded, ground for Pyrolysis. Further, synthetic crude oil may be mixed with process solution and a separator separates the conditioned syncrude oil and process solution. In Pyrolysis (Polystyrene-to-Styrene Monomer (PSM)), waste PS may be melted, “densified” and added with recycled oligomers for Pyrolysis. Further, hydrocarbon gas stream, solids residue streams may lead to condensation to produce styrene monomer.

Further, the variety of processing systems and technologies used in an industry may include Thermal Anaerobic Conversion (TAC) technology to convert end-of-life plastics. Further, Thermal Anaerobic Conversion (TAC) is an industrial process of melting and gasification of plastics followed by condensation & refining. In scientific terms, TAC is a process of controlled cracking of long hydrocarbon chains that can be likened to the activity of a refinery where, instead of crude oil, the input is plastic. Plastics represent some 6% of a refinery's end products and TAC is a reverse process, where using heat in absence of oxygen we bring the plastic back into its “initial” liquid components. With appropriate quality feedstock, the technology conversion ratio is approximately 900 liters of synthetic fuels per 1,000 kg of EOLP. The current version of the plant can convert up to 20 tonnes of feedstock per day, adding up to approximately 7,000 tpa (tonnes per annum) which translates to some 6,000 m3 of CynFuels. Further, TAC is an environmentally beneficial process that reduces the amount of waste that goes to landfill. In addition, TAC has a lower carbon footprint (GHGi, greenhouse gas index) than the production of conventional fuels. The proximity to feedstock and clients affect the GHGi of the end-product. End-Products/Output may include (CynFuels). Further, the CynFuels are the target products and consist of 80% CynDiesel and 20% CynLite. CynFuels are considered as “synthetic transport fuels” under the Alternative Fuel Transport Directive (AFID). By-products are CynGas and char. The CynGas is re-used as fuel in the TAC and the char is sold or taken to a landfill. Although CynFuels can be used in a combustion engine, the production output of existing plants is used at refineries; TAC volumes do not warrant proprietary blending operations.

Further, the variety of processing systems and technologies used in an industry may include depolymerization for decomposing PET back into monomers and then produce a like-new recycled PET pellet. Waste PET and Polyester plastic of all types, shapes, and colors come to the facility from various sources, and using a patented low-energy depolymerization technology, the waste plastic is completely broken down into its monomers: Dimethyl Terephthalate (DMT) and Monoethylene Glycol (MEG)—using low heat and no pressure. The monomers are then purified, removing all coloring, additives, and organic or inorganic impurities. From there, the DMT and MEG are polymerized into PET resin and fiber.

Further, the variety of processing systems and technologies used in an industry may include two types of polyester Recycling technologies (depolymerization glycolysis or methanolysis). Further, the two types of polyester Recycling technologies may include taking PET products (fibers, bottles, carpet) and breaking down these various forms of recovered polyester into the two base monomers, dimethyl terephthalate (DMT) and ethylene glycol, from which virgin polyester is made. The first phase of PRT uses glycolysis to disassemble waste PET into its fundamental building blocks, which are then used to produce new polyesters with high levels of recycled content achieved through certified mass balance allocation. A later phase of PRT using methanol to break down a wide variety of waste polyesters. Further, the glycolysis techniques are now recognized as an innovative environmentally friendly technique due to the involvement of glycols as green solvent/reagent. In glycolysis, polyethylene terephthalate (PET) polymer may be degraded at a molecular level in the presence of trans-esterification catalyst. The most frequently used glycols for this purpose are ethylene glycol, diethylene glycol, propylene glycol, and dipropylene glycol by involving: (1) catalytic, (2) solvent-assisted, (3) supercritical, and microwave-assisted glycolysis. The target of every such modification is the production of value-added material from low-cost waste sources. Further, the methanolysis may include depolymerization by methanolysis consists of three steps. In the first step, methanol penetrates the PET particle and random scission occurs making the PET particle dissolvable solid oligomers. In the second and third step, the solid oligomer is dissolved to liquid oligomer and the dissolved oligomer is converted to DMT and EG.

Further, the variety of processing systems and technologies used in an industry may include Carbon Renewal Recycling (gasification process—“reforming”). Further, Carbon Renewal Recycling may include taking mixed plastics, not limited to polyester, and breaking them down into the basic chemical constituents of carbon monoxide and hydrogen. Those two chemicals, when combined, become syngas.

Further, the variety of processing systems and technologies used in an industry may require procuring post-use plastic types 1 through 7. Once the plastic waste is collected, it is prepped for conversion by shredding, removing metals, drying, and pelletizing. The pelletized plastic material is then heated and vaporized in an oxygen-starved environment. The vapor is captured, cooled into a hydrocarbon liquid, and processed into commercial-grade ultra-low sulfur diesel, naphtha (input for new plastics), and wax. Further, a plastic processing facility, associated with a variety of processing systems and technologies for processing the plastic, may take mixed waste single-use plastics and convert them into usable products on a commercial scale. Further, the plastic processing facility converts approximately 100,000 tons of plastics into over 18 million gallons a year of ultra-low sulfur diesel and naphtha blend stocks and nearly 6 million gallons a year of commercial-grade wax in a process that is expected to be 93 percent efficient. Further, RES Polyflow technology may include a process that is used for converting plastics directly into transportation fuel and other products. Further, the process of pyrolysis is used to break down mixed plastics into diesel, naphtha, and industrial waxes. At the core of the RES Polyflow technology is a process vessel with the ability to handle up to 60 tons per day of mixed polymer waste streams that other recycling systems typically have to discard in landfills. For higher volume feedstreams, multiple RES Polyflow process vessels can be installed in parallel with shared feed-in and product removal sub-systems. The finished product generated by the RES Polyflow process is a light, sweet liquid known as pygas. This stream is equivalent in quality and consistency to benchmark crude oil and can be tailored to the specific requirement of an off-take customer. Diesel fuel, octane enhancers, and gasoline blendstocks are just several of the cuts that can be yielded from the end-product.

Further, the variety of processing systems and technologies used in an industry may include a thermal conversion technology that takes mixed plastics and converts them into liquid oil products. Further, a Polystyrene-to-Styrene Monomer (PSM) System used in the industry may be used to create chemical feedstocks for plastic. Further, the processing system and technologies may be used to convert mixed plastic to crude oil: Pyrolysis of mixed plastic waste that generates a synthetic crude oil that is then conditioned. Further, a system for converting Mixed Plastic to Crude Oil may include a synthetic crude oil delivery system including a source of synthetic crude oil obtained by pyrolysis of one or more materials selected from polymer, plastic, and rubber materials. Further, a system for converting mixed plastic to crude Oil may include a process solution delivery system configured to provide a caustic process solution having a pH of between about 8 and about 10. Further, a mixer may be positioned downstream of the synthetic crude oil delivery system and the process solution delivery system to receive and mix a first volume of the synthetic crude oil with a second volume of the process solution, the first volume of the synthetic crude oil being less than the second volume of the process solution. Further, a separator positioned downstream of the mixer that receives the mixture of synthetic crude oil and process solution, wherein the separator is configured to provide separation of conditioned synthetic crude oil from the process solution.

Further, a system for converting Polystyrene-to-Styrene Monomer includes a mixing, heating, and compacting apparatus to receive a supply of waste polystyrene and to output, a densified polystyrene containing melt; a pyrolysis reactor configured to receive the densified polystyrene containing melt and a supply of recycled oligomers, pyrolyze the densified polystyrene containing melt and the recycled oligomers, and output a hydrocarbon gas stream and a solids residue stream; a quenching apparatus configured to receive the hydrocarbon gas stream output from the pyrolysis reactor and condense out oligomers for routing upstream to the pyrolysis reactor to be combined as the supply of recycled oligomers with the densified polystyrene containing melt, and to discharge an altered hydrocarbon gas stream for further processing; and a condenser configured to receive the altered hydrocarbon gas stream from the quenching apparatus and condense out styrene to form a styrene monomer oil product.

Further, the variety of processing systems and technologies may include Pre-processing of the plastic waste includes industry-standard grinding and shredding to a density target of 20-21 lbs/ft3. The cartridges are filled with plastic feedstock and inserted into a Plastic Reclamation Unit, which is a large processing vessel. A light industrial burner heats air to about 1100° F., and the air may be circulated the exterior of the cartridge while the plastics are transformed from a solid to a liquid, and finally gas. In the gaseous form, the plastics have been broken down into oil-sized molecules. The heating system is closed-loop to diminish heat loss. The gases are removed from the cartridge into a central condensing system with the use of temperature and a vacuum. The gases are cooled in this system and condensed into synthetic crude oil. Waste materials are extracted from the stream, while lightweight gases that do not condense continue downstream. The light gases contain about 80% methane, propane, and butane species. The gases are then treated by an Environmental Control Device. The synthetic crude oil moves into a coalescing and settling process and is eventually moved to an aboveground storage tank outside the facility for transport to a refinery. Crude oil may be refined into ASTM-spec products including ultra-low sulfur diesel. The process is set up to operate continuously, 24 hours a day, seven days a week. It is assumed for purposes of this report that operations occur 312 days a year for 24 hours a day.

Further, the PSM system may be used to produce a liquid from Styrofoam recycling that can be used in pharmaceutical, agricultural, safety, construction, food packaging, durable goods, composites, insulation, and shipping industry products. Further, the MPC system produces a “drop-in” replacement for fossil crude oil, used by refineries throughout the world. Virtually any product generated by a refinery can be produced using the synthetic crude oil product. The only notable exceptions are asphalt products. Because the synthetic crude is a synthetic light, sweet crude oil, it does not contain the “bottoms” used to produce low-end asphalt and tar materials. The lack of “bottoms” also means that a barrel of crude oil will produce more light and middle distillate materials than a typical barrel of fossil crude oil.

All products generated from thermal depolymerization or pyrolysis of waste plastic materials, regardless of technique or use of catalysts, require subsequent refinement before they can be utilized as a finished product(s). Most products used as fuels must adhere to a specification for that fuel. The American Society for Testing and Materials (“ASTM”) is the governing body for the various fuel products utilized in the United States (and other countries). Some products can be used as a “blendstock”, meaning that they are blended with larger amounts of a fuel that already meets the required specifications. In this case, the impact of the blendstock on the finished fuel is not large enough to impact the overall quality of the fuel before dispensation and usage. In general, all products from waste plastics will contain a larger percentage of olefins (unsaturated hydrocarbons) than fossil crude oils. Because of this, hydrogen must be added to the molecules to ensure that the hydrocarbons, when consumed, behave in the same way as those product streams generated by a refinery. In addition, several regulatory hurdles must be cleared both before the production of a substance (TSCA-PMN statutes) and specific usage in on-the-road motor vehicles (fuel registration statutes). These and other minor compliance issues must be addressed before producing and/or selling products directly into the marketplace as finished products.

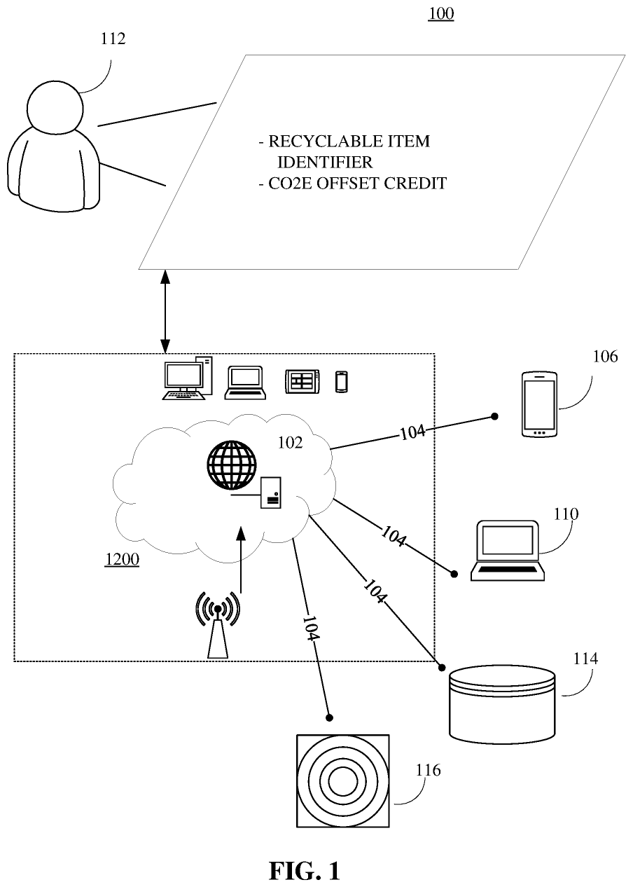

Referring now to figures, FIG. 1 is an illustration of an online platform 100 consistent with various embodiments of the present disclosure. By way of non-limiting example, the online platform 100 to facilitate verifying a recycling process of a recyclable item may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1200.

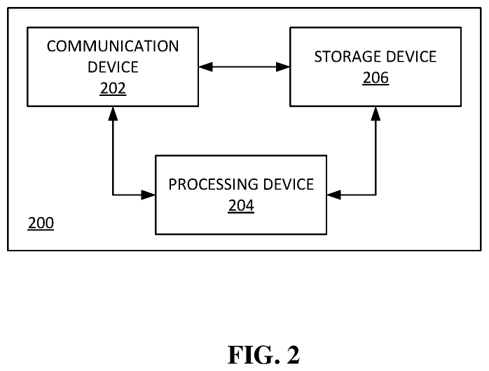

FIG. 2 is a block diagram of a system 200 for facilitating verifying a recycling process of a recyclable item, in accordance with some embodiments. Accordingly, the system 200 may include a communication device 202 configured for receiving a recyclable item identifier of the recyclable item from at least one device. Further, the communication device 202 may be configured for receiving actual yield data representing an actual yield associated with at least one product from a yield sensor. Further, the yield sensor may be configured for generating the actual yield data based on the actual yield of the at least one product produced after processing of the recyclable item using the recycling process.

Further, the system 200 may include a processing device 204 communicatively coupled with the communication device 202. Further, the processing device 204 may be configured for determining estimated yield data representing an estimated yield associated with the recyclable item based on the recyclable item identifier. Further, the processing device 204 may be configured for comparing the actual yield data with the estimated yield data. Further, the processing device 204 may be configured for verifying the recycling process based on the comparing.

Further, the system 200 may include a storage device 206 communicatively coupled with the processing device 204. Further, the storage device 206 may be configured for storing the estimated yield data to a distributed ledger. Further, the storage device 206 may be configured for storing the actual yield data associated with the recyclable item in the distributed ledger.

Further, in some embodiments, the processing device 204 may be configured for generating a CO₂e offset associated with the recyclable item based on the comparing. Further, the storage device 206 may be configured for storing the CO₂e offset in the distributed ledger. Further, in an embodiment, the processing device 204 may be configured for generating a CO2e offset credit associated with the recyclable item based on the generating of the CO2e offset. Further, the processing device 204 may be configured for identifying at least one stakeholder of the recyclable item based on at least one stakeholder identifier. Further, the communication device 202 may be configured for receiving the at least one stakeholder identifier from at least one first device. Further, the at least one first device may include a computing device such as a smartphone, a laptop, a tablet, a desktop, a smartwatch, and so on. Further, the at least one stakeholder identifier may include a stakeholder's name, a stakeholder's image, a stakeholder's unique identification, etc. Further, the communication device 202 may be configured for transmitting the CO2e offset credit to at least one stakeholder device associated with the at least one stakeholder based on the identifying.

Further, in an embodiment, the processing device 204 may be configured for generating a CO₂e offset credit associated with the recyclable item based on the generating of the CO₂e offset. Further, the processing device 204 may be configured for identifying at least one stakeholder of the recyclable item based on a proof of provenance data. Further, the storage device 206 may be configured for retrieving the proof of provenance data of the recyclable item based on the item identifier. Further, the communication device 202 may be configured for transmitting the CO₂e offset credit to at least one stakeholder device associated with the at least one stakeholder based on the identifying.

Further, in some embodiments, the processing device 204 may be configured for generating at least one identifier for the at least one product. Further, the at least one identifier indicates that the at least one product may be recycled. Further, the processing device 204 may be configured for assigning the at least one identifier to the at least one product based on the generating of the at least one identifier. Further, the processing device 204 may be configured for generating at least one product data for the at least one product based on the assigning. Further, the storage device 206 may be configured for storing the at least one product data in the distributed ledger. Further, in an embodiment, the storage device 206 may be configured for retrieving a proof of provenance data associated with the recyclable item based on the recyclable item identifier. Further, the processing device 204 may be configured for identifying at least one stakeholder of the recyclable item based on the proof of provenance data. Further, the processing device 204 may be configured for assigning a provenance of the at least one product to the at least one stakeholder based on the identifying. Further, the generating of the at least one product data may be based on the assigning of the provenance.

Further, in some embodiments, the processing device 204 may be configured for determining estimated measurement data associated with a measurement of an estimated quantity of the recyclable item based on the recyclable item identifier. Further, the processing device 204 may be configured for comparing the estimated measurement data and actual measurement data. Further, the storage device 206 may be configured for storing the estimated measurement data in the distributed ledger. Further, the storage device 206 may be configured for storing the actual measurement data in the distributed ledger. Further, the communication device 202 may be configured for receiving the actual measurement data associated with the measurement of an actual quantity of the at least one product from a measurement sensor. Further, the measurement sensor may be configured for generating the actual measurement data based on measuring the actual quantity of the at least one product. Further, the verifying of the recycling process may be based on the comparing of the estimated measurement data and the actual measurement data. Further, in an embodiment, the estimated quantity may include an estimated lower heat value of the recyclable item. Further, the actual quantity may include an actual lower heat value of the at least one product. Further, the estimated measurement data may include the estimated lower heat value and the actual measurement data may include the actual lower heat value. Further, in an embodiment, the estimated quantity may include an estimated carbon count of the recyclable item. Further, the actual quantity may include an actual carbon count of the at least one product. Further, the estimated measurement data may include the estimated carbon count and the actual measurement data may include the actual carbon count.

Further, in some embodiments, the communication device 202 may be configured for receiving at least one sensor data associated with the recyclable item from at least one sensor. Further, the at least one sensor may be configured for generating the at least one sensor data based on a component of the recyclable item. Further, the processing device 204 may be configured for analyzing the at least one sensor data. Further, the determining of the estimated yield data representing the estimated yield of the recyclable item may be based on the analyzing of the at least one sensor data.

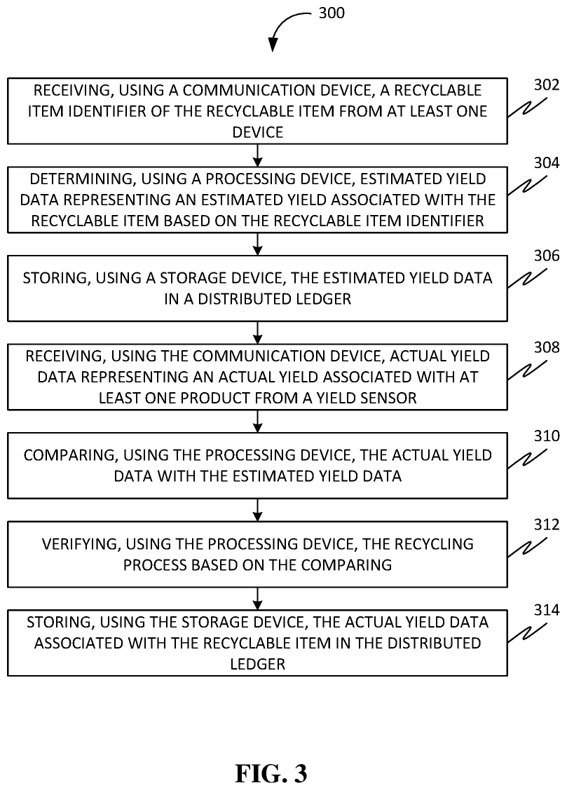

FIG. 3 is a flowchart of a method 300 for facilitating verifying a recycling process of a recyclable item, in accordance with some embodiments. Accordingly, at 302, the method 300 may include a step of receiving, using a communication device, a recyclable item identifier of the recyclable item from at least one device.

Further, at 304, the method 300 may include a step of determining, using a processing device, estimated yield data representing an estimated yield associated with the recyclable item based on the recyclable item identifier.

Further, at 306, the method 300 may include a step of storing, using a storage device, the estimated yield data to a distributed ledger.

Further, at 308, the method 300 may include a step of receiving, using the communication device, actual yield data representing an actual yield associated with at least one product from a yield sensor. Further, the yield sensor may be configured for generating the actual yield data based on the actual yield of the at least one product produced after processing of the recyclable item using the recycling process.

Further, at 310, the method 300 may include a step of comparing, using the processing device, the actual yield data with the estimated yield data.

Further, at 312, the method 300 may include a step of verifying, using the processing device, the recycling process based on the comparing.

Further, at 314, the method 300 may include a step of storing, using the storage device, the actual yield data associated with the recyclable item in the distributed ledger.

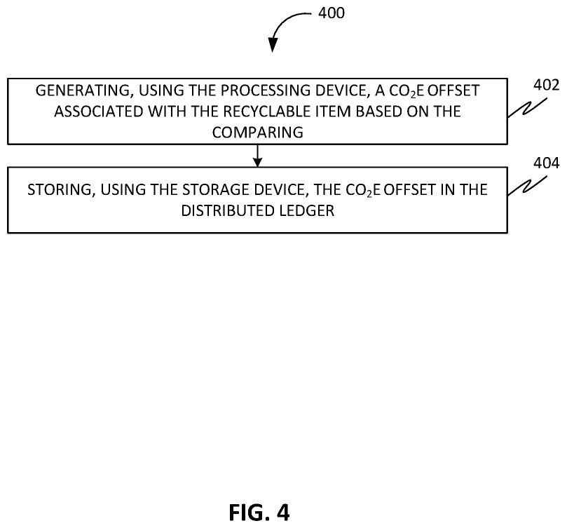

FIG. 4 is a flowchart of a method 400 for generating a CO₂e offset for facilitating verifying the recycling process of the recyclable item, in accordance with some embodiments. Accordingly, at 402, the method 400 may include a step of generating, using the processing device, a CO₂e offset associated with the recyclable item based on the comparing.

Further, at 404, the method 400 may include a step of storing, using the storage device, the CO₂e offset in the distributed ledger.

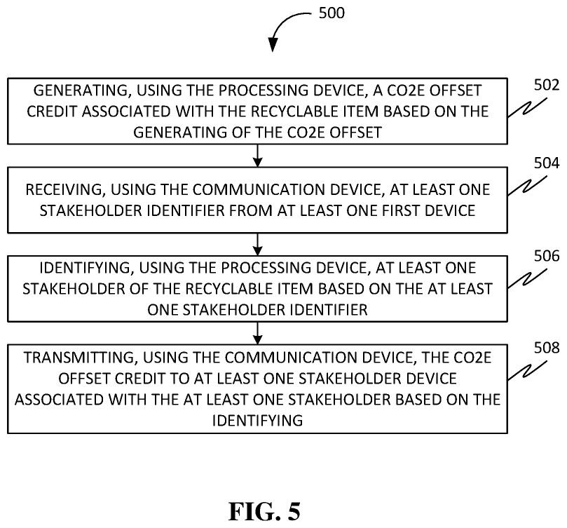

FIG. 5 is a flowchart of a method 500 for identifying at least one stakeholder for facilitating verifying the recycling process of the recyclable item, in accordance with some embodiments. Accordingly, at 502, the method 500 may include a step of generating, using the processing device, a CO₂e offset credit associated with the recyclable item based on the generating of the CO₂e offset.

Further, at 504, the method 500 may include a step of receiving, using the communication device, at least one stakeholder identifier from at least one first device. Further, the at least one first device may include a computing device such as a smartphone, a laptop, a tablet, a desktop, a smartwatch, and so on.

Further, at 506, the method 500 may include a step of identifying, using the processing device, at least one stakeholder of the recyclable item based on the at least one stakeholder identifier.

Further, at 508, the method 500 may include a step of transmitting, using the communication device, the CO₂e offset credit to at least one stakeholder device associated with the at least one stakeholder based on the identifying.

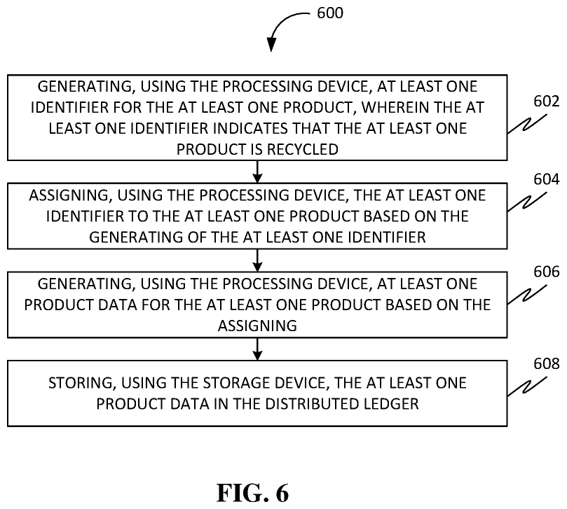

FIG. 6 is a flowchart of a method 600 for generating at least one product data for facilitating verifying the recycling process of the recyclable item, in accordance with some embodiments. Accordingly, at 602, the method 600 may include a step of generating, using the processing device, at least one identifier for the at least one product. Further, the at least one identifier indicates that the at least one product may be recycled.

Further, at 604, the method 600 may include a step of assigning, using the processing device, the at least one identifier to the at least one product based on the generating of the at least one identifier.

Further, at 606, the method 600 may include a step of generating, using the processing device, at least one product data for the at least one product based on the assigning.

Further, at 608, the method 600 may include a step of storing, using the storage device, the at least one product data in the distributed ledger.

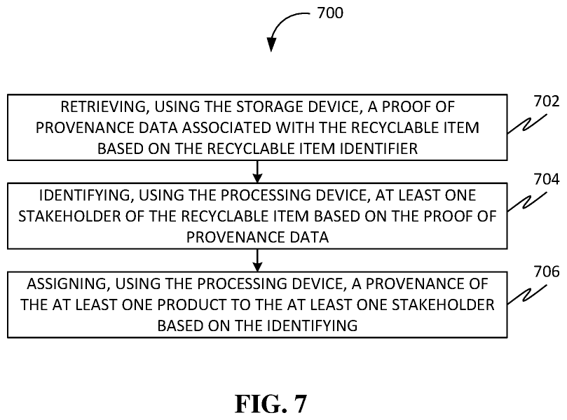

FIG. 7 is a flowchart of a method 700 for assigning a provenance for facilitating verifying the recycling process of the recyclable item, in accordance with some embodiments. Accordingly, at 702, the method 700 may include a step of retrieving, using the storage device, a proof of provenance data associated with the recyclable item based on the recyclable item identifier.

Further, at 704, the method 700 may include a step of identifying, using the processing device, at least one stakeholder of the recyclable item based on the proof of provenance data.

Further, at 706, the method 700 may include a step of assigning, using the processing device, a provenance of the at least one product to the at least one stakeholder based on the identifying. Further, the generating of the at least one product data may be based on the assigning of the provenance.

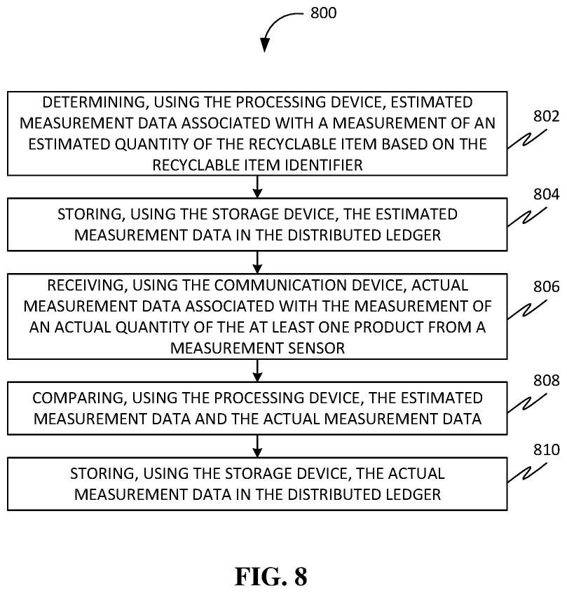

FIG. 8 is a flowchart of a method 800 for comparing estimated measurement data and actual measurement data for facilitating verifying the recycling process of the recyclable item, in accordance with some embodiments. Accordingly, at 802, the method 800 may include a step of determining, using the processing device, estimated measurement data associated with a measurement of an estimated quantity of the recyclable item based on the recyclable item identifier.

Further, at 804, the method 800 may include a step of storing, using the storage device, the estimated measurement data in the distributed ledger.

Further, at 806, the method 800 may include a step of receiving, using the communication device, actual measurement data associated with the measurement of an actual quantity of the at least one product from a measurement sensor. Further, the measurement sensor may be configured for generating the actual measurement data based on measuring the actual quantity of the at least one product.

Further, at 808, the method 800 may include a step of comparing, using the processing device, the estimated measurement data and the actual measurement data. Further, the verifying of the recycling process may be based on the comparing of the estimated measurement data and the actual measurement data.

Further, at 810, the method 800 may include a step of storing, using the storage device, the actual measurement data in the distributed ledger.

Further, in some embodiments, the estimated quantity may include an estimated lower heat value of the recyclable item. Further, the actual quantity may include an actual lower heat value of the at least one product. Further, the estimated measurement data may include the estimated lower heat value and the actual measurement data may include the actual lower heat value.

Further, in some embodiments, the estimated quantity may include an estimated carbon count of the recyclable item. Further, the actual quantity may include an actual carbon count of the at least one product. Further, the estimated measurement data may include the estimated carbon count and the actual measurement data may include the actual carbon count.

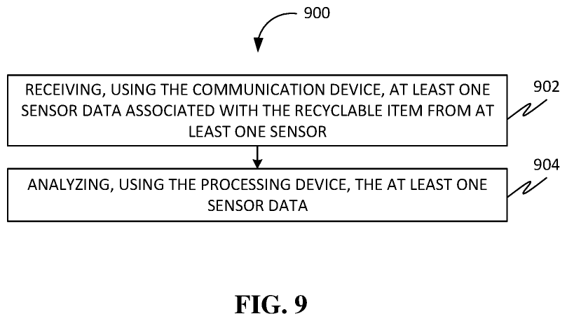

FIG. 9 is a flowchart of a method 900 for determining the estimated yield of the recyclable item for facilitating verifying the recycling process of the recyclable item, in accordance with some embodiments. Accordingly, at 902, the method 900 may include a step of receiving, using the communication device, at least one sensor data associated with the recyclable item from at least one sensor. Further, the at least one sensor may be configured for generating the at least one sensor data based on a component of the recyclable item.

Further, at 904, the method 900 may include a step of analyzing, using the processing device, the at least one sensor data. Further, the determining of the estimated yield data representing the estimated yield of the recyclable item may be based on the analyzing of the at least one sensor data.

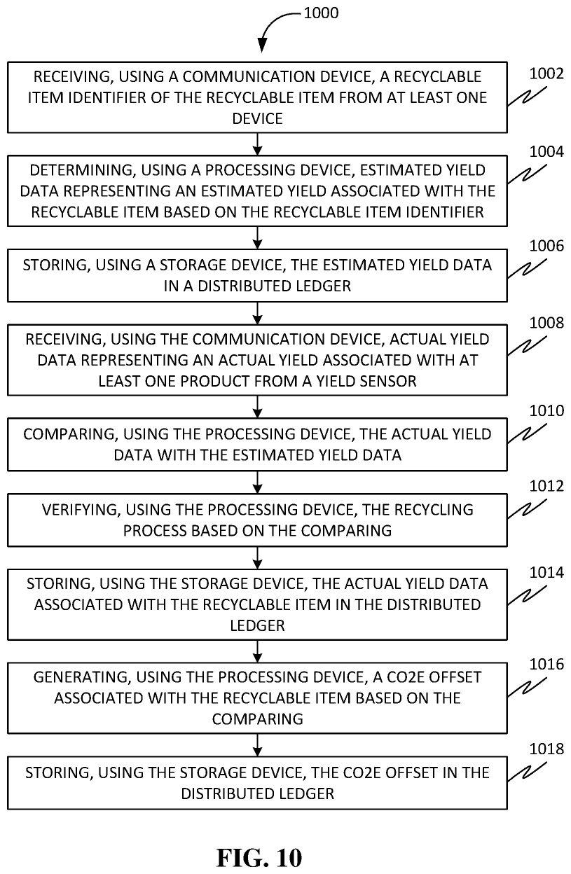

FIG. 10 is a flowchart of a method 1000 for facilitating verifying a recycling process of a recyclable item, in accordance with some embodiments. Accordingly, at 1002, the method 1000 may include a step of receiving, using a communication device, a recyclable item identifier of the recyclable item from at least one device.

Further, at 1004, the method 1000 may include a step of determining, using a processing device, estimated yield data representing an estimated yield associated with the recyclable item based on the recyclable item identifier.

Further, at 1006, the method 1000 may include a step of storing, using a storage device, the estimated yield data to a distributed ledger.

Further, at 1008, the method 1000 may include a step of receiving, using the communication device, actual yield data representing an actual yield associated with at least one product from a yield sensor. Further, the yield sensor may be configured for generating the actual yield data based on the actual yield of the at least one product produced after processing of the recyclable item using the recycling process.

Further, at 1010, the method 1000 may include a step of comparing, using the processing device, the actual yield data with the estimated yield data.

Further, at 1012, the method 1000 may include a step of verifying, using the processing device, the recycling process based on the comparing.

Further, at 1014, the method 1000 may include a step of storing, using the storage device, the actual yield data associated with the recyclable item in the distributed ledger.

Further, at 1016, the method 1000 may include a step of generating, using the processing device, a CO₂e offset associated with the recyclable item based on the comparing.

Further, at 1018, the method 1000 may include a step of storing, using the storage device, the CO₂e offset in the distributed ledger.

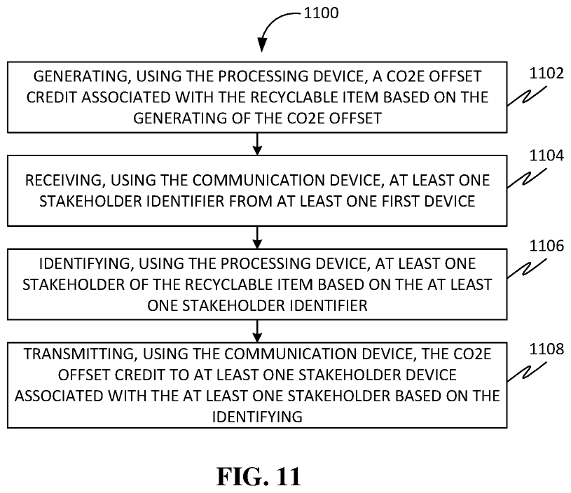

FIG. 11 is a flowchart of a method 1100 for identifying at least one stakeholder for facilitating the verifying the recycling process of the recyclable item, in accordance with some embodiments. Accordingly, at 1102, the method 1100 may include a step of generating, using the processing device, a CO₂e offset credit associated with the recyclable item based on the generating of the CO₂e offset.

Further, at 1104, the method 1100 may include a step of receiving, using the communication device, at least one stakeholder identifier from at least one first device. Further, the at least one first device may include a computing device such as a smartphone, a laptop, a tablet, a desktop, a smartwatch, and so on.

Further, at 1106, the method 1100 may include a step of identifying, using the processing device, at least one stakeholder of the recyclable item based on the at least one stakeholder identifier.

Further, at 1108, the method 1100 may include a step of transmitting, using the communication device, the CO₂e offset credit to at least one stakeholder device associated with the at least one stakeholder based on the identifying.

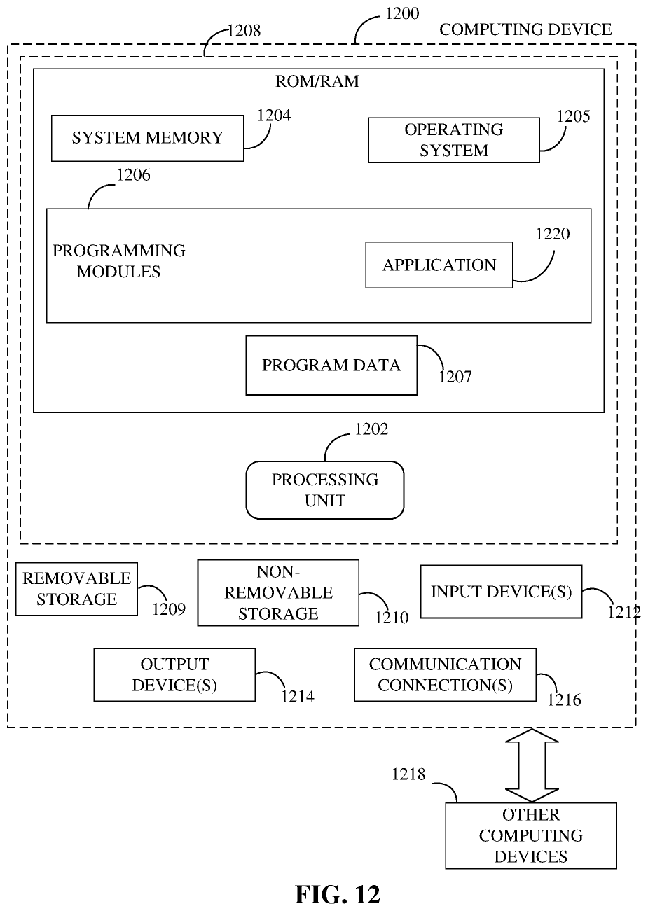

With reference to FIG. 12, a system consistent with an embodiment of the disclosure may include a computing device or cloud service, such as computing device 1200. In a basic configuration, computing device 1200 may include at least one processing unit 1202 and a system memory 1204. Depending on the configuration and type of computing device, system memory 1204 may comprise, but is not limited to, volatile (e.g. random-access memory (RAM)), non-volatile (e.g. read-only memory (ROM)), flash memory, or any combination. System memory 1204 may include operating system 1205, one or more programming modules 1206, and may include a program data 1207. Operating system 1205, for example, may be suitable for controlling computing device 1200's operation. In one embodiment, programming modules 1206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 12 by those components within a dashed line 1208.

Computing device 1200 may have additional features or functionality. For example, computing device 1200 may also include additional data storage devices (removable and/or non-removable) such as, for example, magnetic disks, optical disks, or tape. Such additional storage is illustrated in FIG. 12 by a removable storage 1209 and a non-removable storage 1210. Computer storage media may include volatile and non-volatile, removable and non-removable media implemented in any method or technology for storage of information, such as computer-readable instructions, data structures, program modules, or other data. System memory 1204, removable storage 1209, and non-removable storage 1210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a touch input device, a location sensor, a camera, a biometric sensor, etc. Output device(s) 1214 such as a display, speakers, a printer, etc. may also be included. The aforementioned devices are examples and others may be used.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1204, including operating system 1205. While executing on processing unit 1202, programming modules 1206 (e.g., application 1220 such as a media player) may perform processes including, for example, one or more stages of methods, algorithms, systems, applications, servers, databases as described above. The aforementioned process is an example, and processing unit 1202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

1. A method for facilitating verifying a recycling process of a recyclable item, the method comprising:
receiving, using a communication device, a recyclable item identifier of the recyclable item from at least one device;
determining, using a processing device, estimated yield data representing an estimated yield associated with the recyclable item based on the recyclable item identifier;
storing, using a storage device, the estimated yield data in a distributed ledger;
receiving, using the communication device, actual yield data representing an actual yield associated with at least one product from a yield sensor, wherein the yield sensor is configured for generating the actual yield data based on the actual yield of the at least one product produced after processing of the recyclable item using the recycling process;
comparing, using the processing device, the actual yield data with the estimated yield data;
verifying, using the processing device, the recycling process based on the comparing; and
storing, using the storage device, the actual yield data associated with the recyclable item in the distributed ledger.

2. The method of claim 1 further comprising:
generating, using the processing device, a CO₂e offset associated with the recyclable item based on the comparing; and
storing, using the storage device, the CO₂e offset in the distributed ledger.

3. The method of claim 2 further comprising:
generating, using the processing device, a CO₂e offset credit associated with the recyclable item based on the generating of the CO₂e offset;
receiving, using the communication device, at least one stakeholder identifier from at least one first device;
identifying, using the processing device, at least one stakeholder of the recyclable item based on the at least one stakeholder identifier; and
transmitting, using the communication device, the CO₂e offset credit to at least one stakeholder device associated with the at least one stakeholder based on the identifying.

4. The method of claim 1 further comprising:
generating, using the processing device, at least one identifier for the at least one product, wherein the at least one identifier indicates that the at least one product is recycled;
assigning, using the processing device, the at least one identifier to the at least one product based on the generating of the at least one identifier;
generating, using the processing device, at least one product data for the at least one product based on the assigning; and
storing, using the storage device, the at least one product data in the distributed ledger.

5. The method of claim 4 further comprising:
retrieving, using the storage device, a proof of provenance data associated with the recyclable item based on the recyclable item identifier;
identifying, using the processing device, at least one stakeholder of the recyclable item based on the proof of provenance data; and
assigning, using the processing device, a provenance of the at least one product to the at least one stakeholder based on the identifying, wherein the generating of the at least one product data is further based on the assigning of the provenance.

6. The method of claim 1 further comprising:
determining, using the processing device, estimated measurement data associated with a measurement of an estimated quantity of the recyclable item based on the recyclable item identifier;
storing, using the storage device, the estimated measurement data in the distributed ledger;
receiving, using the communication device, actual measurement data associated with the measurement of an actual quantity of the at least one product from a measurement sensor, wherein the measurement sensor is configured for generating the actual measurement data based on measuring the actual quantity of the at least one product;
comparing, using the processing device, the estimated measurement data and the actual measurement data, wherein the verifying of the recycling process is further based on the comparing of the estimated measurement data and the actual measurement data; and
storing, using the storage device, the actual measurement data in the distributed ledger.

7. The method of claim 6, wherein the estimated quantity comprises an estimated lower heat value of the recyclable item, wherein the actual quantity comprises an actual lower heat value of the at least one product, wherein the estimated measurement data comprises the estimated lower heat value and the actual measurement data comprises the actual lower heat value.

8. The method of claim 6, wherein the estimated quantity comprises an estimated carbon count of the recyclable item, wherein the actual quantity comprises an actual carbon count of the at least one product, wherein the estimated measurement data comprises the estimated carbon count and the actual measurement data comprises the actual carbon count.

9. The method of claim 1 further comprising:
receiving, using the communication device, at least one sensor data associated with the recyclable item from at least one sensor, wherein the at least one sensor is configured for generating the at least one sensor data based on a component of the recyclable item; and
analyzing, using the processing device, the at least one sensor data, wherein the determining of the estimated yield data representing the estimated yield of the recyclable item is further based on the analyzing of the at least one sensor data.

10. A method for facilitating verifying a recycling process of a recyclable item, the method comprising:
receiving, using a communication device, a recyclable item identifier of the recyclable item from at least one device;
determining, using a processing device, estimated yield data representing an estimated yield associated with the recyclable item based on the recyclable item identifier;
storing, using a storage device, the estimated yield data in a distributed ledger;
receiving, using the communication device, actual yield data representing an actual yield associated with at least one product from a yield sensor, wherein the yield sensor is configured for generating the actual yield data based on the actual yield of the at least one product produced after processing of the recyclable item using the recycling process;
comparing, using the processing device, the actual yield data with the estimated yield data;
verifying, using the processing device, the recycling process based on the comparing;
storing, using the storage device, the actual yield data associated with the recyclable item in the distributed ledger.
generating, using the processing device, a CO₂e offset associated with the recyclable item based on the comparing; and
storing, using the storage device, the CO₂e offset in the distributed ledger.

11. The method of claim 10 further comprising:
generating, using the processing device, a CO₂e offset credit associated with the recyclable item based on the generating of the CO₂e offset;
receiving, using the communication device, at least one stakeholder identifier from at least one first device;
identifying, using the processing device, at least one stakeholder of the recyclable item based on the at least one stakeholder identifier; and
transmitting, using the communication device, the CO₂e offset credit to at least one stakeholder device associated with the at least one stakeholder based on the identifying.

12. A system for facilitating verifying a recycling process of a recyclable item, the system comprising:
a communication device configured for:
receiving a recyclable item identifier of the recyclable item from at least one device; and
receiving actual yield data representing an actual yield associated with at least one product from a yield sensor, wherein the yield sensor is configured for generating the actual yield data based on the actual yield of the at least one product produced after processing of the recyclable item using the recycling process;
a processing device communicatively coupled with the communication device, wherein the processing device is configured for:
determining estimated yield data representing an estimated yield associated with the recyclable item based on the recyclable item identifier;
comparing the actual yield data with the estimated yield data; and
verifying the recycling process based on the comparing; and
a storage device communicatively coupled with the processing device, wherein the storage device is configured for:
storing the estimated yield data in a distributed ledger; and
storing the actual yield data associated with the recyclable item in the distributed ledger.

13. The system of claim 12, wherein the processing device is further configured for generating a CO₂e offset associated with the recyclable item based on the comparing, wherein the storage device is further configured for storing the CO₂e offset in the distributed ledger.

14. The system of claim 13, wherein the processing device is further configured for:
generating a CO₂e offset credit associated with the recyclable item based on the generating of the CO₂e offset; and
identifying at least one stakeholder of the recyclable item based on at least one stakeholder identifier, wherein the communication device is further configured for:
receiving the at least one stakeholder identifier from at least one first device; and
transmitting the CO₂e offset credit to at least one stakeholder device associated with the at least one stakeholder based on the identifying.

15. The system of claim 12, wherein the processing device is further configured for:
generating at least one identifier for the at least one product, wherein the at least one identifier indicates that the at least one product is recycled;
assigning the at least one identifier to the at least one product based on the generating of the at least one identifier; and
generating at least one product data for the at least one product based on the assigning, wherein the storage device is further configured for storing the at least one product data in the distributed ledger.

16. The system of claim 15, wherein the storage device is further configured for retrieving a proof of provenance data associated with the recyclable item based on the recyclable item identifier, wherein the processing device is further configured for:
identifying at least one stakeholder of the recyclable item based on the proof of provenance data; and
assigning a provenance of the at least one product to the at least one stakeholder based on the identifying, wherein the generating of the at least one product data is further based on the assigning of the provenance.

17. The system of claim 12, wherein the processing device is further configured for:
determining estimated measurement data associated with a measurement of an estimated quantity of the recyclable item based on the recyclable item identifier;
comparing the estimated measurement data and actual measurement data, wherein the storage device is further configured for:
storing the estimated measurement data in the distributed ledger; and
storing the actual measurement data in the distributed ledger, wherein the communication device is further configured for receiving the actual measurement data associated with the measurement of an actual quantity of at least one product from a measurement sensor, wherein the measurement sensor is configured for generating the actual measurement data based on measuring the actual quantity of the at least one product, wherein the verifying of the recycling process is further based on the comparing of the estimated measurement data and the actual measurement data.

18. The system of claim 17, wherein the estimated quantity comprises an estimated lower heat value of the recyclable item, wherein the actual quantity comprises an actual lower heat value of the at least one product, wherein the estimated measurement data comprises the estimated lower heat value and the actual measurement data comprises the actual lower heat value.

19. The system of claim 17, wherein the estimated quantity comprises an estimated carbon count of the recyclable item, wherein the actual quantity comprises an actual carbon count of the at least one product, wherein the estimated measurement data comprises the estimated carbon count and the actual measurement data comprises the actual carbon count.

20. The system of claim 12, wherein the communication device is further configured for receiving at least one sensor data associated with the recyclable item from at least one sensor, wherein the at least one sensor is configured for generating the at least one sensor data based on a component of the recyclable item, wherein the processing device is further configured for analyzing the at least one sensor data, wherein the determining of the estimated yield data representing the estimated yield of the recyclable item is further based on the analyzing of the at least one sensor data.
